(19) United States
(12) Patent Application Publication
(10) Pub. No.: US 2017/0124906 A1
(43) Pub. Date: May 4, 2017

(54) SYSTEM AND METHOD FOR ENABLING A USER TO OVERCOME PERFECTIONISM

(71) Applicants: Jonnalagadda Sasidhar, Sleepy Hollow, NY (US); Gopi Ambikapathi Ambekar, Bangalore (IN); Sreenidhi Sundaran, Bangalore (IN)

(72) Inventors: Jonnalagadda Sasidhar, Sleepy Hollow, NY (US); Gopi Ambikapathi Ambekar, Bangalore (IN); Sreenidhi Sundaran, Bangalore (IN)

(73) Assignee: DHARMA LIFE SCIENCES LLC, Sleepy Hollow, NY (US)

(21) Appl. No.: 14/985,472

(22) Filed: Dec. 31, 2015

Related U.S. Application Data
(63) Continuation-in-part of application No. 14/931,868, filed on Nov. 4, 2015.

(51) Int. Cl. G09B 19/00; A63F 13/5375; G09B 5/02

(52) U.S. Cl. CPC G09B 19/00; G09B 5/02; A63F 13/5375

(57) ABSTRACT

A system is provided for enabling a user to overcome perfectionism. The system is configured to enable the user to engage in a first and a second activity in a virtual environment, directed to rewire a first and a second defective wiring, respectively. The first defective wiring results in an individual prioritizing on errors in a task more than the completion of the task. The second defective wiring results in inability to weigh between the errors in the task and the completion of the task. Symptom of the first and the second defective wirings is perfectionism. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome perfectionism, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, perfectionism may be caused by genetic predisposition, for example, an individual whose parents exhibited perfectionist behavior may grow up to exhibit perfectionism. Environmental factors such as, an individual being praised for his achievements, an individual being challenged that they are not as good as their siblings, parents, or friends, or an individual being cautioned about making mistakes at all times, which instills the fear of failure, may be responsible for perfectionism.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a perfectionist may include exhibiting excessive cleanliness or fear of contamination, orderliness or engagement in routine behaviors that include repetitive arranging, organizing or lining up of objects until certain conditions are met or the end result feels “just right”, trying to achieve perfection in whatever they attempt to do, hence spending much of their time rechecking and correcting any errors in their work until they find it perfect, hesitation in delegating their work to others as they think that the other person will make certain mistakes, tendency to find errors while sharing work with others and redoing the whole work all over again, among others.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome perfectionism, which can be classified as a weak personality trait based on the goals of the person.

### SUMMARY

An embodiment provides a system for enabling a user to overcome perfectionism. The system includes an activity module. The activity module is configured to enable the user to engage in at least a first activity in a virtual environment. The first activity is directed to rewire a first defective wiring of the brain. The first defective wiring results in an individual prioritizing on errors in a task more than the completion of the task. The activity module is further configured to enable the user to engage in at least a second activity in the virtual environment. The second activity is directed to rewire a second defective wiring of the brain. The second defective wiring results in inability to weigh between the errors in the task and the completion of the task. Symptom of the first and the second defective brain wirings is perfectionism. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome perfectionism. The method includes enabling the user to engage in at least a first activity in a virtual environment. The first activity is directed to rewire a first defective wiring of the brain. The first defective wiring results in an individual prioritizing on errors in a task more than the completion of the task. The user is enabled to engage in at least a second activity in the virtual environment. The second activity is directed to rewire a second defective wiring of the brain. The second defective wiring results in inability to weigh between the errors in the task and the completion of the task. Symptom of the first and the second defective wirings is perfectionism. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome perfectionism. The system includes an activity module configured to enable the user to engage in at least a first activity in a virtual environment, wherein the first activity is directed to rewire a first defective wiring of the brain, wherein the first defective wiring results in an individual prioritizing on errors in a task more than the completion of the task. The activity module is further configured to enable the user to engage in at least a second activity in the virtual environment, wherein the second activity is directed to rewire a second defective wiring of the brain, wherein the second defective wiring results in inability to weigh between the errors in the task and the completion of the task, wherein symptom of the first and the second defective wirings is perfectionism, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome perfectionism;

FIG. 2 is a block diagram of an exemplary activity module 200 to overcome perfectionism;

FIG. 2A is a block diagram of an exemplary behavioral traits database 202 of the activity module 200 to overcome perfectionism;

FIG. 2B is a block diagram of an exemplary collection of games 204 present in the activity module 200 to overcome perfectionism;

FIG. 2C is a block diagram of an exemplary actions database 206 of the activity module 200 to overcome perfectionism; and

FIG. 3 illustrates a flowchart of an exemplary method for overcoming perfectionism.

### DETAILED DESCRIPTION

I. OVERVIEW
II. PRINCIPLE
III. SYSTEM ARCHITECTURE
IV. MODULES OF SYSTEM TO OVERCOME PERFECTIONISM
V. METHOD FOR OVERCOMING PERFECTIONISM

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome perfectionism, which is a weak behavioral trait. The solution is based on a principle that genetic and environmental factors (may be referred to as “cause”) cause defects in human brain wiring (may be referred to as “defect”), and such defects in human brain wiring express themselves in the form of perfectionism (may be referred to as “symptoms”); hence, to overcome perfectionism, the defective brain wirings have to be rewired, thereby providing a wholesome and long term solution to weak behavioral traits.

In an embodiment, a system is provided to overcome perfectionism. The system may include an activity module. The activity module may be configured to enable the user to engage in activities in a virtual environment. The activities in the virtual environment facilitate rewiring of defective brain wirings, wherein the symptom of the defective brain wirings is perfectionism. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Perfectionism is a personality trait characterized by a person's striving for flawlessness and setting excessively high performance standards, accompanied by overly critical self-evaluations and concerns regarding others evaluations. Perfectionists are concerned about various subjects such as cleanliness, orderliness and organization, performance, and delegation.

Perfectionism is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to perfectionism, the brain of a perfectionist is wired such that the person tends to prioritize on errors in a task more than the completion of the task, which may be a defective brain wiring. Additionally, the brains of perfectionists are wired such that they are unable to weigh between the errors in the task and the completion of the task, which may be considered as another defective brain wiring. Such defective brain wiring may have been caused by one or more of genetic predisposition, for example, an individual whose parents exhibited perfectionist behavior may grow up to exhibit perfectionism. Additionally, environmental factors contribute to such defective brain wirings. For example, individuals who are praised for their achievements, set a standard for themselves, and they feel pressured to maintain that standard; individuals who are challenged that they are not as good as their siblings, parents, or friends, grow up struggling to achieve a certain level of perfection in order to feel worthy and accepted. Further, when individuals are cautioned about making mistakes all the time, it instills fear of failure, which can cause them to overcompensate by exaggerated efforts to achieve, may be responsible for causing perfectionism.

Embodiments provide a solution to rewire the defective brain wirings (addressing the defect) rather than just addressing the behavioral trait (symptom) without addressing the core defect. The solution is directed towards rewiring the defective brain wirings such that the ability to focus on the completion of the task is increased and ability to weigh between the errors in the task and the completion of the task is increased.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Perfectionists tend to prioritize on errors in a task more than the completion of the task, and they are unable to weigh between the errors in the task and the completion of the task. Different brain regions and neural network of the individual are responsible for such defects. Perfectionism is caused due to the overactive neuronal pattern in the error detection part of the brain i.e. orbito frontal cortex (OFC). A pattern of deceptive or error message associated with fear (Amygdala) is repeated up the hierarchy without allowing other network patterns which are necessary for an individual's daily life. OFC detects this abnormal excitation of neuronal pattern and sends an alert signal. In normal condition, when a pattern of neurons is excited over and over again, an inhibitory system for these patterns gets activated and this mechanism is carried out by the neurons from right inferior frontal gyrus (RIFG). It detects the cue from OFC and at the same time inhibits the repetitive neuronal network from getting excited. This provides a scope for the other pattern of neuronal network to move up the hierarchy and achieve normal neuronal activity. Thus RIFG regulates the incoming repetitive neuronal patterns from dominating the whole cortical system. But in the case of perfectionists, there has been a deficit of these RIFG neurons and hence impaired regulation of the repetitive error patterns.

### III. System Architecture

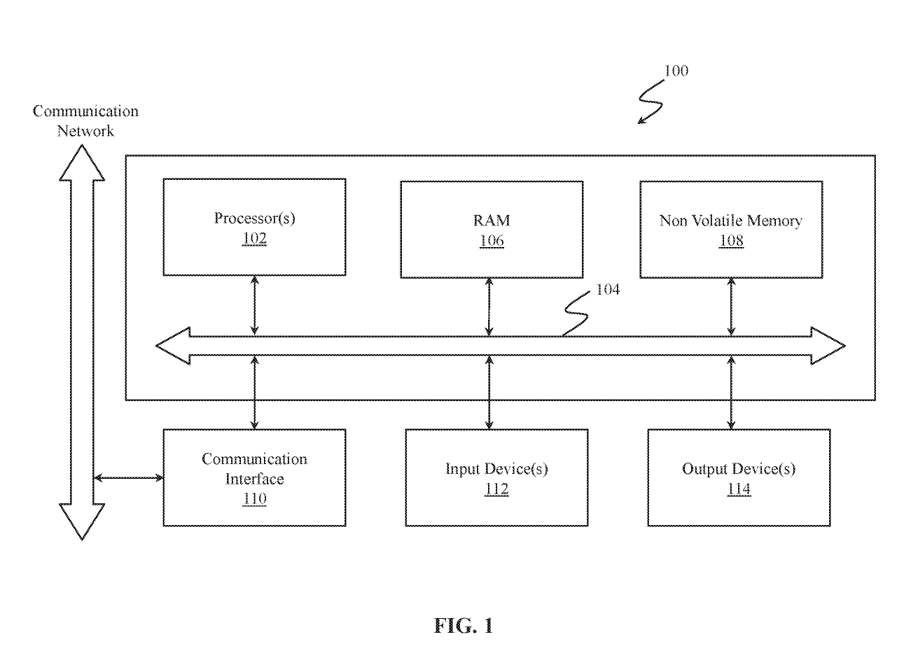

Referring to the figures, more particularly to FIG. 1, an exemplary architecture of an exemplary system 100 to overcome perfectionism is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Perfectionism

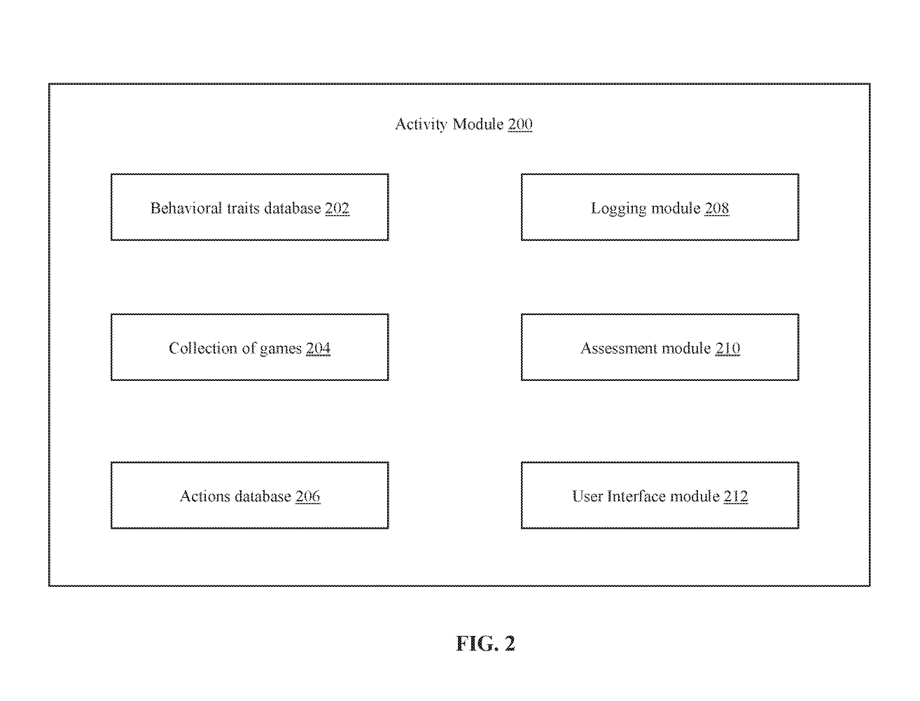

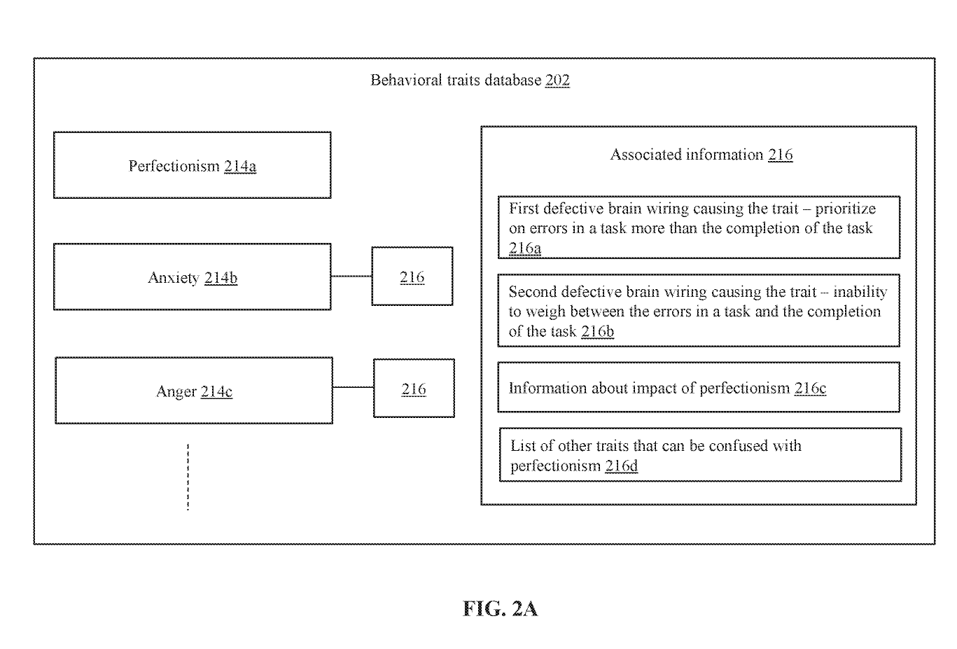

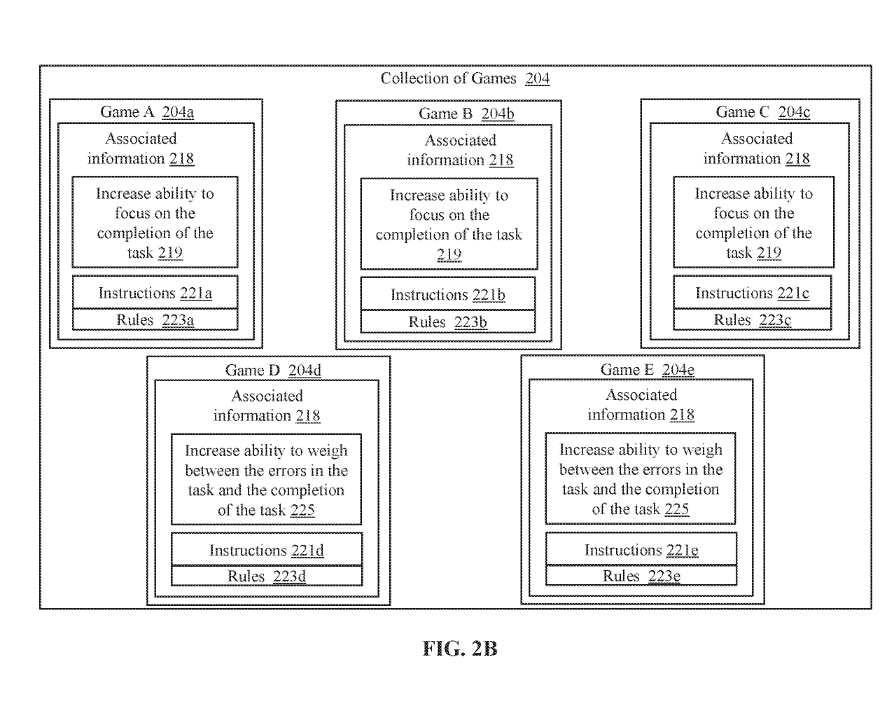

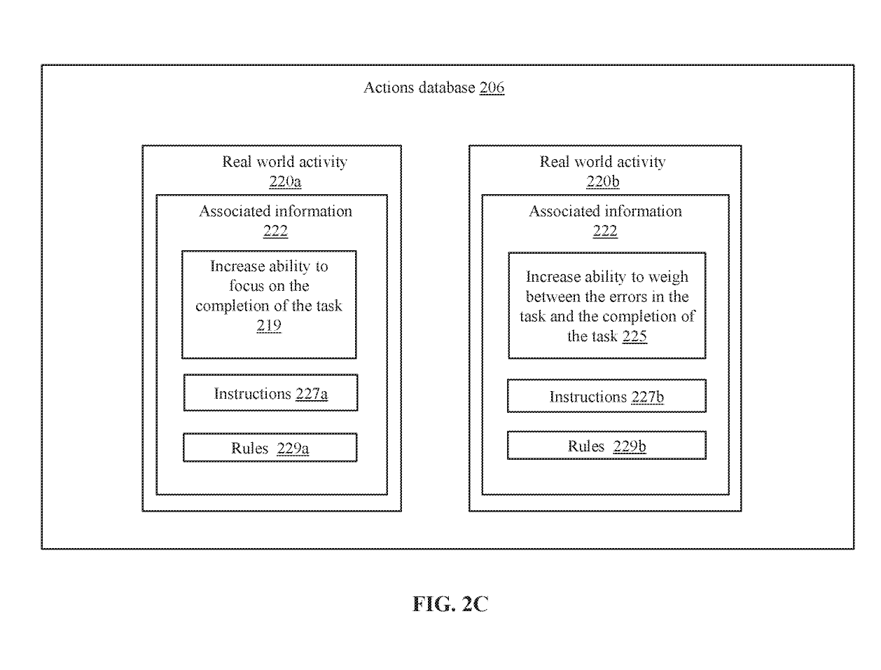

Referring to the figures, and more particularly to FIG. 2, the system 100 includes various modules for enabling users to overcome perfectionism. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, perfectionism 214a, anxiety 214b and anger 214c, among others. The traits database 202 may further include, with respect to one or more of the behavioral traits, information associated 216 with the trait 214.

With regards to perfectionism 214a, the associated information 216 may include information corresponding to the defective brain wirings (defects) 216a and 216b causing perfectionism (symptom of the defect), information about impact 216c of perfectionism 214a on a person, and a list 216d comprising one or more traits that may be confused with perfectionism 214a, among other information. Some or all of the associated information 216 may be displayed to the user of the activity module 200.

A first defective brain wiring 216a causing perfectionism 214a is the brain wiring causing an individual to prioritize on errors in a task more than the completion of the task. A second defective brain wiring 216b causing perfectionism 214a is the brain wiring causing inability to weigh between the errors in the task and the completion of the task.

In an embodiment, the information corresponding to the first and second defective brain wiring 216a and 216b causing perfectionism 214a enables the activity module 200 to select games, activities or actions to overcome perfectionism 214a.

In an embodiment, displaying the information corresponding to the defective brain wiring (defect) 216a, 216b causing perfectionism 214a helps the user in understanding the defects responsible for perfectionism 214a, thereby motivating the user to follow the instructions provided by the activity module 200.

Information about impact 216c of perfectionism 214a can include one or more of information corresponding to a perfectionists perception of cleanliness or fear of contamination, orderliness or engagement in routine behaviors that include repetitive arranging, organizing or lining up of objects until certain conditions are met or the end result feels “just right”, trying to achieve perfection in whatever they attempt to do, hence spending much of their time rechecking and correcting any errors in their work until they find it perfect, hesitation in delegating their work to others as they think that the other person will make certain mistakes, tendency to find errors while sharing work with others and redoing the whole work all over again, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome perfectionism 214a.

With regards to perfectionism 214a, the brain rewiring attempted to achieve to overcome perfectionism 214a includes rewiring the defective brain wirings 216a, 216b such that ability to focus on the completion of a task is increased and ability to weigh between the errors in the task and the completion of the task is increased.

In an embodiment, the activity module 200 may display the information corresponding to the causes (genetic or environmental) that resulted in the defective brain wirings (defect) 216a, 216b, which in turn resulted in perfectionism 214a, thereby enabling the user to relate to the cause, defect and symptom of the defect, which results in a wholesome experience while working to overcome perfectionism 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204e (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, different games 204a-204e are included in the collection of games 204. The games 204a-204e can be used by the activity module 200 to correct the defective brain wirings 216a and 216b by rewiring the brain to increase the ability to focus on the completion of the task 219 and increase the ability to weigh between the errors in the task and the completion of the task 225.

In an embodiment, one or more games among games 204a-204e may be played to overcome the defective brain wiring 219 and one or more games among games 204a-204e may be played to overcome the defective brain wiring 225. One or more of the games among games 204a-204e may be common to both the wirings 219 and 225.

In an embodiment, and as an example, Games 204a-204c may be directed at rewiring 219 the brain to increase the ability to focus on the completion of the task. Games 204d-204e may be directed at rewiring 225 the brain to increase the ability to weigh between the errors in the task and the completion of the task.

Game A 204a may be designed to rewire the brain to increase the ability to focus on the completion of the task 219. Game A 204a may be a frame game, where the user is presented with a wall with various frames arranged in an order. The instruction 221a may include recommendation to tilt the frames as randomly as possible. Further, instructions 221a may include recommendation to play the game 204a for a minimum duration every day. The rules 223a may allow proceeding to a next level in the game 204a once a desired level of performance is achieved. Game A 204a may include a plurality of complexities. Complexities may be defined by the activity module 200 on a scale of 1 to 10, as an example.

When the complexity is 1, the user will be presented with frames of equal size. The user is instructed to tilt the frames as randomly as possible. When the complexity is 2, the frames are of same size arranged as per the color coordination. The user may be instructed to tilt the frame and at the same time rearrange the position as randomly as possible. When the complexity is 3, the frames are of different sizes, landscape and portrait arranged as per the color coordination. The user has to tilt the frame and at the same time rearrange the position as randomly as possible. Rules 223a may recommend that the user has to achieve 80% randomness in each complexity to reach the next complexity.

Game B 204b may be designed to rewire the brain to increase the ability to focus on completion of the task 219. Game B 204b may be a book shelf game, where the user is presented with three rows of book shelves and is instructed to arrange the books as randomly as possible. Instructions 221b may include recommendation to play the game 204b for a minimum duration every day. The rules 223b may allow proceeding to a next level in the game 204b once a desired level of performance is achieved. Game B 204b may include a plurality of complexities.

When the complexity is 1, the user will be instructed to interchange the books within each shelf. When the complexity is 2, the user is instructed to interchange the books within each shelf, spread it across and tilt. When the complexity is 3, the user is instructed to interchange the books between the shelves. When the complexity is 4, the user is instructed to interchange the books between the shelves, spread it across and tilt.

Game C 204c may be designed to rewire the brain to increase the ability to focus on the completion of the task 219. Game C 204c may be a task oriented game, where the user is presented with a text which contains errors. The goal is to enable the user to overlook the errors which are ignorable and prioritize completion of the task. The instruction 221c may include recommendation to play the game 204c for a minimum duration every day. The rules 223c may allow proceeding to a next level in the game 204c once a desired level of performance is achieved. Game C 204c may include a plurality of levels and each level may include plurality of levels of complexities.

In a first level, the individual is instructed to type the sentences given, which does not include errors. The goal of the task is to type the sentences as it is at one stretch without reverting back. Options are available for the users to go back and change the typing errors if any, but the goal of the task is not to do so. When the complexity is 1, within the first level, the words in the sentences are very simple ones. When the complexity is 2, within the first level, one or two words in a sentence are complex ones. When the complexity is 3, within the first level, more than two words are complex to type.

In a second level, the individual is instructed to type the sentences given, wherein errors are introduced. The goal of the task is to type the sentences as it is at one stretch without reverting back. Options are available for the user to go back and change the typing errors if any, but the goal of the task is not to do so. When the complexity is 1, within the second level, the induced errors are punctuations. When the complexity is 2, within the second level, induced errors are punctuations and spelling mistakes.

In a third level of game 204c, the individual is instructed to retype sentences given, wherein minor and major errors are introduced. Minor errors are those which are ignorable and major ones are those which will change the meaning of the sentences and has to be corrected. Hence user has to correct the major errors and retain minor ones as such.

In a fourth level, the individual is instructed to retype sentences given, wherein minor and major errors are introduced. User has to correct the major errors and retain minor ones as such. A part of the work has to be delegated to the system (select the sentence and click the ‘delegate’ button). The users should ignore the errors made in the delegated work

Game D 204d may be designed to enhance one's ability to weigh between the errors in the task and the completion of the task 225. The instruction 221d may include recommendation to play the game 204d for at least a predefined duration for a predefined number of days. The rules 223d may allow proceeding to a next level in the game 204d once a desired level of performance is achieved.

As an example, a situation/event may be presented to the user. The user is further presented with a plurality of positive and negative facts associated with the situation. The user has to decide and choose the appropriate answer based on the evaluation of the facts based on a subset of facts displayed. One example with all the facts is shown of which only a subset will be shown at a time is presented below:

### Situation:

1. The document that your subordinate submitted to your boss is not aligned.

### Positive Facts:

The alignment can be corrected, the importance is to analyze the idea in the document.
The deadline was short.
It is the initial draft of the document.
Your subordinate has given proper documents in the past.
Your subordinate submitted without alignments as he wanted feedback from you to make the final document.
Your boss is concerned about the matter than the alignment.
There are authorized people who will take care of aesthetics of the document.
Alignments will neither improve nor bring down the quality of the content.
Most of the documents from several departments are submitted without proper alignment.
There is no history of reprimand from the superior with regards to the aesthetics.

### Negative Facts:

The alignment is very important as it will determine the first impression according to you.
Without alignment, the document will look incomplete.
If the document is not appealing, the proposal can be affected.
If the document is not aligned, it will look imperfect.
If the document is not aligned well, your colleagues might judge you for being unorganized.
The content might not have been conveyed properly if it's not aligned.
It is comparatively easier to read when aligned.
It shows your subordinate was careless this time
Your subordinate does not prioritize alignments of the document.
Rest of your team members might follow the same path.
   Would you focus on the alignment?
Yes
No

Game E 204e may be designed to enhance one's ability to weigh between the errors in the task and the completion of the task 225. The instruction 221e may include recommendation to play the game 204e for at least a predefined duration for a predefined number of days. The rules 223e may allow proceeding to a next level in the game 204e once a desired level of performance is achieved.

In game 204e, the individuals are presented with a scenario where many conflicts will be created. The task of the individual is to read the scenario and answer by choosing among the possibilities provided. Through this task, the individual will be aware that the beliefs they carry so strongly can be incorrect. One example is presented below.

### Scenario/Situation:

Four friends departed for a long drive. While on their way, the car stopped in the middle of the road because of overheated radiator, they had to pool up the water they had carried back from the home to cool the radiator. Only one bottle is left which was being used by all of them. You, among the friends, are a perfectionist who doesn't share or drink water from others bottle as you feel that you may get infected. In the mean time your friends thought of having some snacks which was brought from home; as you had travelled for a long time. Your friends offered the food and water.
Q. So in this situation, would you share the snacks and drink the water which is being used by the rest of your friends?
A:
   The snacks and water is being used by everyone so I wouldn't drink or eat.
   They have not washed their hands before consuming so I wouldn't touch it.
   As that is the only bottle of water that is left. So I will have to drink.

Scenario/Situation:
You resist the thirst and hunger when everyone was drinking and eating on the way. Though you observe that other friends who drank the water from the bottle are still doing fine and they do not seem sick.
Q. So in this situation, would you drink the water after seeing your friends doing fine?
A:
   As they might fall sick sometime later, I wouldn't drink.
   If I drink I'm sure I will fall sick.
   Because my friends seems fine, which means I can drink as I'm very thirsty and hungry.

### Scenario/Situation:

As you continued your journey, you with your friends started walking into a village, the path was very small. You walked about 10 km in search of food and accommodation. As you couldn't find a place to eat, your friends had to depend on the packet of snacks that are left out. So they offered the snacks to you.
Q. So in this situation, would you eat the snacks now or not?
A:
   I do not like to eat what others are also eating.
   The snacks do not look very hygienic.
   I have been starving, I should eat something before I faint.

### Scenario/Situation:

Then you encounter a stranger who was walking by and he happens to be a native of the village. He shares the details of the food points that are available in the village and you realized that you people have to walk to reach the destination. The stranger offers you fruits which are rotten on one side, so your friends offer you the fruit.
Q. So in this situation, would you eat the fruit that is spoilt or not?
A:
   The fruit is spoilt and eating that will obviously make me fall sick.
   There was worm that came out of the fruit.
   Eating the parts that is not spoilt will have no problem.
   It will take another few hours to reach the food point mentioned by the stranger, so it's better for me to eat the available fruit.

### Scenario/Situation:

As its getting darker, all of you were really hungry and desperately wanted to eat something. To your surprise, you found a small food point inside the village which was not maintained in a good condition. As there was no other nearby restaurants we had to depend on whatever we had come across. The person who was the most hungry and thirsty was you. Others have no issues neither with the place nor with the food. Though it was a little messy, they all acquired the resistance to ignore the cleanliness and enjoyed the meal as it was a matter of survival for them.
Q. So in this situation, would you eat from this place which is not clean?
A:
   The place seems very untidy, dirty. If I eat there, I might suffer from food poison.
   We may not find other places further the way, as the villager mentioned there is no other food point this route.
   I am very hungry now by all the starving, I just cannot wait any longer, as I will fall sick by not eating.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b (may be referred by numeral 220) or sets of real world activities 220a-220b (may be referred by numeral 220) is used by the activity module 200 based on the brain rewiring 219, 225, which the real world activity 220 is capable of achieving.

Each real world activity 220a, 220b may include associated information 222. As an example, a real world activity may be capable of achieving more than one type of brain rewiring. Each real world activity 220a, 220b includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others. Each level alternative should have an editable option where users can edit what is written and do what they think is feasible for that day, such that whatever they write, should be saved as that alternative and will show up 5 times.

The real world activity 220a may be presented to the user after the user has at least participated in one or more games (204a-204c) to a predefined extent that attempts to rewire 219 the first defective brain wiring 216a. The real world activity 220a may be designed to rewire the brain to increase the ability to focus on the completion of the task. Instructions 227a may include recommendation that the action has to be carried out every day. For example, rules 229a may include recommendations that each level has to be repeated 5 times, before the next level unlocks.

In a first level, instructions 227a may be provided to the user to choose a quiet place to sit in and close the eyes and imagine in detail what is shown on a screen. The activity module 200 may choose the tasks to be shown on the screen sequentially and display it to the user.

### Screen 1:

Imagine yourself completing a task in your college/work space, which has few typos, but you have to submit in an hour. Also imagine you submitting the file without making the changes. While imagining, keep breathing deeply and feel the relaxation through your body.
Imagine yourself going for a presentation 15 minutes late, you being able to complete the presentation successfully. While imagining, keep breathing deeply and feel the relaxation through your body.
Imagine yourself leaving the house without keeping the things in place and going to your college/work. Imagine you carrying out the action without feeling any uneasiness. While imagining, keep breathing deeply and feel the relaxation through your body.
Imagine yourself using a public restroom when you are traveling and not falling sick. Imagine you carrying out the action without feeling any uneasiness. While imagining, keep breathing deeply and feel the relaxation through your body.
Imagine yourself delegating one of your tasks to one of your colleague, and the task being completed with no errors, with which your boss also seems very happy with the task. Imagine you carrying out the action without feeling any uneasiness. While imagining, keep breathing deeply and feel the relaxation through your body.

In a second level, the activity module 200 may choose the tasks to be shown on the screen sequentially and display it to the user.

### Screen 1:

After lunch or dinner, push the chairs below the table without prioritizing uniform arrangement.
After washing the clothes and drying them, place them into the closet without arranging them based on color, size etc.
After washing the dishes arrange them in the rack randomly.
After completion of your work arrange your files and other stationary randomly and leave the office.
Request your friend/spouse to arrange your desk/closet and do not make any changes

In a third level, the activity module 200 may choose the tasks to be shown on the screen sequentially and display it to the user.

### Screen 1:

Give a feedback for the food you had in a restaurant without rechecking.
Comment on your friends updates in a social network with minor mistakes.
Write a letter or message to your dear ones, with minor errors in it.
Talk at a meeting without rehearsing what you are going to say.
Ask your colleague/subordinate to type a letter for you and send it without checking.

### Screen 2:

By the end of the day, please write down your feelings and how you have coped successfully with each situation. An empty box may be provided to type the user's response.

In a fourth level, the activity module 200 may choose the tasks to be shown on the screen sequentially and display it to the user.

### Screen 1:

Refraining from cleaning your vehicle's interiors for a week.
Create a status that has few minor typos and refrain from changing the status for a week.
Refrain from organizing furniture at home for a week.
Park your vehicle in a random direction for week.
Refrain from arranging your kitchen for a week.

In a fifth level, the activity module 200 may choose the tasks to be shown on the screen sequentially and display it to the user.

### Screen 1:

One day go to your college/office without tidying your house.
When playing sport, deliberately miss a shot or lose a match.
Invite friends and provide food that is ok rather than perfect.
Show up for a meeting with boss at the wrong time.
Wear a shirt/top that has a visible stain on it.

The real world activity 220b may be presented to the user after the user has at least participated in one or more games (204d and 204e) to a predefined extent that attempts to rewire 225 the second defective brain wiring 216b. The real world activity 220b may be designed rewire the brain to increase the ability to weigh between the errors in the task and the completion of the task 225. Instructions 227b may include recommendation that the action has to be repeated once in a week and rules 229b may state that each level has to be repeated 3 times, before the next level unlocks. Real world activity 220b may include a plurality of levels.

In a first level, instructions 227a may be provided to the user to choose a quiet place to sit in and close the eyes and imagine in detail what is shown on a screen. The activity module 200 may choose the tasks to be shown on the screen and display it to the user sequentially.

### Screen 1:

Imagine you are in an examination hall, though you have not revised a part of your syllabus, still you are confident of scoring good as you were very attentive during classes. Imagine you carrying out the action without feeling any uneasiness. While imagining, keep breathing deeply and feel the relaxation through your body.
Imagine you are preparing a dish and you found an ingredient missing, but still you will proceed as the dish can be prepared even without that particular ingredient. Imagine you carrying out the action without feeling any uneasiness. While imagining, keep breathing deeply and feel the relaxation through your body.
Imagine you are going for a interview and you are giving a resume that is not aligned well, yet you are appreciated for your academic skills and achievements, Imagine you carrying out the action without feeling any uneasiness. While imagining, keep breathing deeply and feel the relaxation through your body.
Imagine you are packing for a vacation and in the last minute you figured it out that you didn't carry linens. You started without linens as you can buy them later. Imagine you carrying out the action without feeling any uneasiness. While imagining, keep breathing deeply and feel the relaxation through your body.
Imagine you are in your colleague's cabin that is very disorganized, try to imagine you feeling very comfortable in the cabin and you being able to do a great job with your colleague.

In a second level, the activity module 200 may choose the tasks to be shown on the screen and display it to the user sequentially.

### Screen 1:

When you are thirsty, visit a juice centre (street), if they have maintained everything clean, order for a juice.
When your hair has grown, visit a saloon/boutique, ask the shop owner to clean the area if it's not and get your hair cut done.
When you go to buy groceries, visit a shopping mall, check the quality of the products and not the shop aesthetics and make a buy.
When you are sending an office document to your manager, deliberately send a wrong file.
When you are in a meeting, talk without rehearsing what has to be said in your head.

In a third level, the activity module 200 may choose the tasks to be shown on the screen and display it to the user sequentially.

### Screen 1:

Wear a shirt that has visible creases and refrain from ironing the shirt/top and go to your office.
Wear your shoes that are not polished and refrain from polishing and go to your office.
Go out one day without grooming yourself/putting any make up.
Wear a random dress to a party or get together.
When you are in a meeting, deliberately take a break.
Go for a vacation without preplanning.

In a fourth level, the activity module 200 may choose the tasks to be shown on the screen and display it to the user sequentially.

### Screen 1:

When you are hungry, visit a restaurant nearby which is not well maintained.
Deliberately touch a garbage bag and refrain from washing your hands for an hour.
Visit a karaoke club, sing without rehearsing.
Visit a hospital and volunteer to help the underprivileged people.
Volunteering in cleanliness program.

In a fifth level, the user may be provided instructions 227b to mentor another individual who is a perfectionist (and who wants to change) and guide them on the skills that you have learned. This person could be your friend/family member or colleague.

In an embodiment, the action database 206 further includes plurality of physical actions, mind actions and dietary actions, one or more of which may be presented to a user who is trying to overcome perfectionism 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Perfectionism

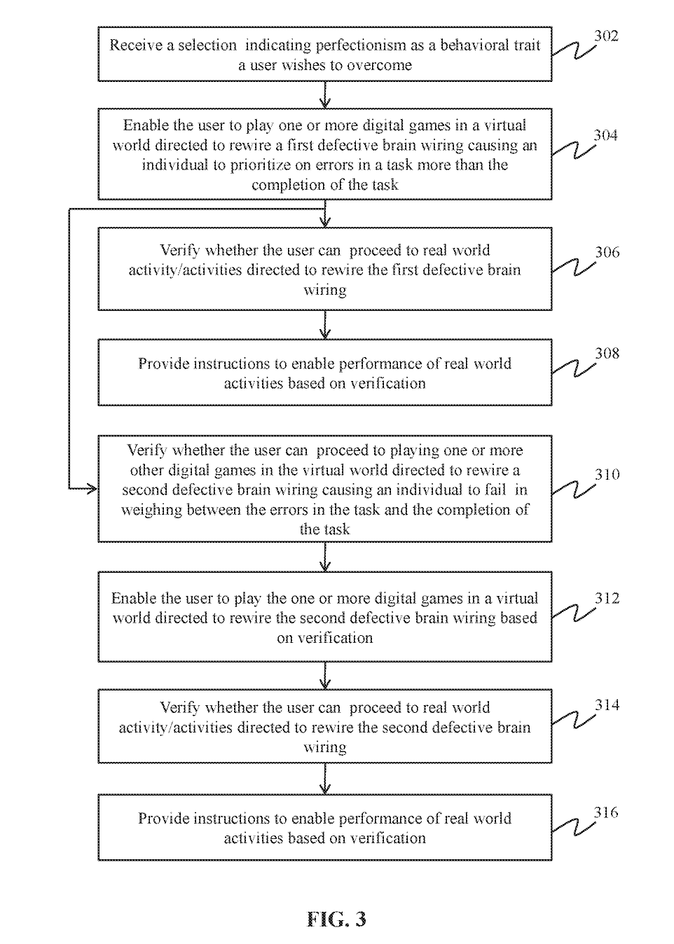

Now referring more particularly to FIG. 3, a method is provided for overcoming perfectionism 214a. A selection indicating perfectionism 214a as a behavioral trait which a user wishes to overcome is received at step 302. At step 304, a user is enabled to play/participate in one or more digital games 204a-204c, which are played in a virtual world. The digital games 204a-204c are instrumental in rewiring 219 a first defective brain wiring 216a, whose symptom is exhibition of perfectionism 214a. At step 306, verification is made to determine whether the user can proceed to perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in at least one or all of the digital games 204a, 204b and 204c at least to a predefined extent, which is determined based on the desired rewiring. The real world activity 220a is instrumental in rewiring 219 the first defective brain wiring 216a, whose symptom is exhibition of perfectionism 214a.

At step 310, verification is made to determine whether the user can proceed to playing one or more other digital games 204d and/or 204e in the virtual world directed to rewire a second defective brain wiring 216b. In case it is determined that user can proceed, then at step 312 the user is enabled to participate/play in the one or more digital games 204d and/or 204e, which is played in a virtual world. The digital games 204d and 204e are instrumental in rewiring 225 the second defective brain wiring 216b, whose symptom is exhibition of perfectionism 214a. Preferably, the user is allowed to proceed to playing at least one or all of the digital games 204d and 204e upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in at least one or all of the digital game(s) 204 and 204e at least to a predefined extent, which is determined based on the desired rewiring. The real world activity 220b are instrumental in rewiring 225 the second defective brain wiring 216b, whose symptom is exhibition of perfectionism 214a.

Referring to the step (302) of receiving a selection indicating perfectionism 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of perfectionism 214a, the activity module 200 may display a list 216d of other behavioral traits that can be confused with perfectionism 214a, so that the user can select a more appropriate behavioral trait 214, which he desires to work on. The activity module 200 may further display the information corresponding to the brain wirings (defect) 216a, 216b causing the behavioral trait 214. The first defective brain wiring 216a causes the individual to prioritize on errors in a task more than the completion of the task. The second defective brain wiring 216b causes inability to weigh between the errors in the task and the completion of the task.

The activity module 200 may additionally display information about impact 216c of perfectionism 214a to the user. In addition, the activity module 200 may display information corresponding to the brain rewiring 219 and 225 that the activity module 200 is attempting to achieve to overcome perfectionism 214a. Rewiring 219 of the first defective brain wiring 216a results in increased ability to focus on the completion of the task. Rewiring 225 of the second defective brain wiring 216b results in increased ability to weigh between the errors in the task and the completion of the task.

Furthermore, the activity module 200 may display the information corresponding to the causes (genetic or environmental) that resulted in the defective brain wirings (defect) 216a, 216b.

Referring to the step (304) of enabling the user to play one or more digital games in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220. Preferably, the activity module 200 recommends real world activities 220 after the user has performed to a desired extent in the digital game(s) 204. Desired extent of performance can be, as an example, levels completed, score reached and duration over which the game 204 was played.

In an embodiment, the activity module 200 recommends participating in real world activity 220a or a part thereof, after the user has performed to a desired extent in at least one or all of the digital games 204a-204c. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a-204c), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing at least one or more other digital games in the virtual world directed to rewire the second defective brain wiring 216b causing an individual to fail in weighing between the errors in the task and the completion of the task. Rewiring the second defective brain wiring 216b results in ability to weigh between the errors in the task and the completion of the task.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and real world activity/activities directed to rewire the first defective brain wiring 216a.

The activity module 200, based on the verification, enables the user to play/participate in one or more other digital games 204d and 204e in the virtual world directed to rewire the second defective brain wiring 216b.

In an embodiment, the activity module 200 recommends participating in real world activity 220b or part thereof after the user has performed to a desired extent in the digital game 204d. Likewise, the activity module 200 recommends participating in real world activity 220b or part thereof after the user has performed to a desired extent in the digital game 204e. In another embodiment, the activity module 200 recommends participating in digital game 204e after the user has performed to a desired extent in a level of the digital game 204d.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting perfectionism, the activity module 200 provides a scale operable by the user to select a position on the scale. The position may be indicative of the user's perception of his perfectionism. Improvement in perfectionism resulting from the rewiring of the brain achieved by the performance of the activities (virtual games or real world activities) enabled by the activity module 200 is reflected on the scale. Degradation of the improvement in perfectionism resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome perfectionism, the system comprising an activity module configured to:
enable the user to engage in at least a first activity in a virtual environment, wherein the first activity is directed to rewire a first defective wiring of the brain, wherein the first defective wiring results in prioritizing on errors in a task more than the completion of the task;
enable the user to engage in at least a second activity in the virtual environment, wherein the second activity is directed to rewire a second defective wiring of the brain, wherein the second defective wiring results in inability to weigh between the errors in the task and the completion of the task, wherein symptom of the first and the second defective wirings is perfectionism;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome perfectionism, the method comprising:
enabling the user to engage in at least a first activity in a virtual environment, wherein the first activity is directed to rewire a first defective wiring of the brain, wherein the first defective wiring results in prioritizing on errors in a task more than the completion of the task;
enabling the user to engage in at least a second activity in the virtual environment, wherein the second activity is directed to rewire a second defective wiring of the brain, wherein the second defective wiring results in inability to weigh between the errors in the task and the completion of the task, wherein symptom of the first and the second defective wirings is perfectionism;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity, after the user has at least participated in the first activity.

11. A system for enabling a user to overcome perfectionism, the system comprising an activity module configured to:
enable the user to engage in at least a first activity in a virtual environment, wherein the first activity is directed to rewire a first defective wiring of the brain, wherein the first defective wiring results in prioritizing on errors in a task more than the completion of the task; and
enable the user to engage in at least a second activity in the virtual environment, wherein the second activity is directed to rewire a second defective wiring of the brain, wherein the second defective wiring results in inability to weigh between the errors in the task and the completion of the task, wherein symptom of the first and the second defective wirings is perfectionism, wherein engagement in the second activity is enabled after the user has at least participated in the first activity.

12. The system of claim 11, wherein,
the first activity is directed to rewire the first defective wiring to increase the ability to focus on the completion of the task; and
the second activity is directed to rewire the second defective wiring to increase the ability to weigh between the errors in the task and the completion of the task.
